(19) United States
(12) Patent Application Publication
(10) Pub. No.: US 2022/0319178 A1
(43) Pub. Date: Oct. 6, 2022

(54) Systems And Methods For Providing Monitoring, Optimization, And Control Of Pool/Spa Equipment Using Video Analytics

(71) Applicant: Hayward Industries, Inc., Berkeley Heights, NJ (US)

(72) Inventors: James Carter, Warren, RI (US); Gregory Fournier, West Kingston, RI (US); Jason Davila, North Kingston, RI (US); Arthur W. Johnson, III, Stoughton, MA (US); Louis Pereira, Assonet, MA (US); Troy Renken, Mooresville, NC (US); Nagaraj B. Jayanth, Beavercreek, OH (US); Kevin L. Potucek, Naples, FL (US)

(73) Assignee: Hayward Industries, Inc., Berkeley Heights, NJ (US)

(21) Appl. No.: 17/608,734

(22) PCT Filed: May 1, 2020
(86) PCT No.: PCT/US2020/031075

§ 371 Date: Nov. 3, 2021

Related U.S. Application Data
(60) Provisional application No. 62/842,939, filed on May 3, 2019.

(51) Int. Cl. G06V 20/52; G06V 20/00; G06V 10/764

(52) U.S. Cl. CPC G06V 20/52; G06V 20/35; G06V 10/764

(57) ABSTRACT

Systems and methods for monitoring, optimization, and control of pool/spa equipment using video analytics are provided. A camera system in communication with a microprocessor monitors a pool/spa environment, identifies objects of interest in the pool/spa environment, classifies the objects of interest, and identifies scenarios and/or learned behaviors of objects utilizing video analytics. The analytics can include object detection in combination with tracking algorithms in order to precisely locate objects of interest within the video frames. Further image classification and scene labeling algorithms may be used to classify the object in order to define its attributes. Once processed, the system can transmit alerts or commands to pool/spa users and devices to modify the operation thereof based on the identified attributes of the objects of interest.

### CROSS-REFERENCE TO RELATED APPLICATIONS

This application claims the benefit of priority to U.S. Provisional Patent Application Ser. No. 62/842,939, filed on May 3, 2019, the entire disclosure of which is hereby incorporated by reference.

### FIELD OF THE INVENTION

The present disclosure relates to systems and methods for providing monitoring, optimization, and control of pool/spa equipment using video analytics.

### RELATED ART

Pool/spa automation systems can rely on the use of external sensors located in close proximity to the operation that is intended to be monitored. Each operation may require the use of multiple sensors with specialized functions in order to provide the system with the required telemetry data to perform automated behavior. Additionally, with the growth of computer vision technologies, machine learning, and artificial intelligence, it would be beneficial if such technologies could augment the present capabilities of pool/spa automation systems.

Accordingly, what is needed is an effective system that can actively monitor multiple operations concurrently using an image capture device and computer vision technologies, thus reducing the complexity and cost of the infrastructure required by current pool/spa automation systems.

### SUMMARY OF THE INVENTION

The present disclosure relates to systems and methods for providing monitoring, optimization, and control of pool/spa equipment using video analytics. The present disclosure can include a camera system in communication with a microprocessor the monitors a pool/spa environment, identifies objects of interest in the pool/spa environment, classifies the objects of interest, and identifies scenarios and/or learned behaviors of objects utilizing video analytics software. These analytics can include object detection in combination with tracking algorithms in order to precisely locate objects of interest within the video frames. Further image classification and scene labeling algorithms may be used to classify the object in order to define its attributes. Once processed, the system can transmit alerts or commands to pool/spa users and devices to modify the operation thereof based on the identified attributes of the objects of interest.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure;

FIG. 2 is a diagram illustrating an image frame captured by the system of FIG. 1;

FIG. 3 is a flowchart illustrating processing steps carried out by the system of FIG. 1; and

FIG. 4 is a block diagram illustrating hardware and software components of a system of the present disclosure.

### DETAILED DESCRIPTION

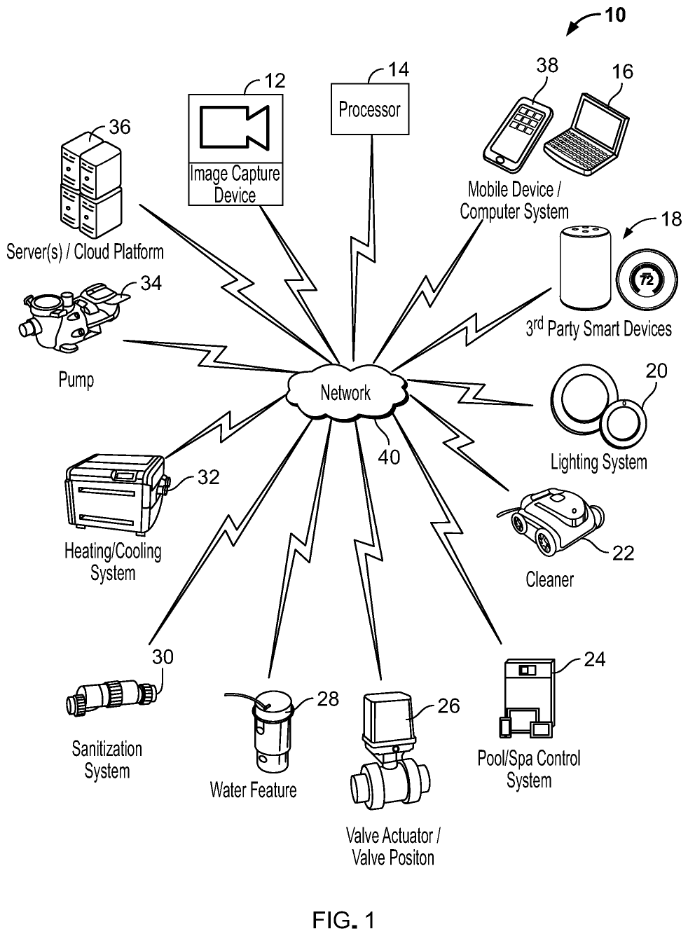

The present disclosure relates to systems and methods for providing network connectivity and remote monitoring, optimization and control of pool/spa equipment, as discussed in detail below in connection with FIGS. 1-4.

FIG. 1 is a diagram illustrating the system 10 of the present disclosure. Generally, the system 10 monitors a pool/spa environment using an image capture device 12 directed towards the pool/spa environment, identifies one or more objects of interest and attributes thereof using a processor 14 that applies video analytics algorithms to image and/or video information obtained by the image capture device 12, and determines an action to be taken based on this information. For example, the system 10 can communicate an alert to a user, or control the operation of one or more pool/spa devices based on the attributes of the one or more objects of interest.

The image capture device 12 can include one or more of a high resolution camera, an infrared (IR) or thermal imaging camera, or a light detection and ranging (LIDAR) system. The processor 14 can be integrated into the image capture device 12, or it can be a separate device. For example, the processor 14 can be located at the pool/spa environment and communicate with the image capture device 12 by way of a local network, or the processor 14 could be located remotely, such as in a cloud-based pool/spa control system and communicate with the image capture device 12 by way of the Internet.

As shown in FIG. 1, the system 10 can include various types of pool/spa equipment, such as, a pump 34, a heating/cooling system 32, a sanitization system 30, a water feature 28, a valve actuator 26, a pool/spa control system 24, a pool cleaner 22, and/or a lighting system 20. The system 10 can also include, or be in communication with, other systems such as a remote server/“cloud”-based control system 36, a computer system 16, a mobile device 38 (e.g., smart phone), 3^{rd} party smart devices 18 (e.g., voice-enabled speakers, connected home appliances, etc.), and combinations thereof.

The devices of system 10 can communicate with each other over a network 40, which could include, but is not limited to, the Internet. Of course, as would be known to one of ordinary skill in the art, the network 40 can provide for communication between the devices of system 10 using one or more of wired (e.g., RS485, ethernet, USB, serial, etc.), wireless (e.g., Wifi, Bluetooth, ZigBee, ZWave, cellular, thread, etc.), and direct communication protocols and combinations thereof. While the foregoing discussion references network 40, it shall be understood that the present system can be a self-contained system that does not include network connectivity or cloud communication capabilities. For example, in such a system, the image capture device 12 and processor 14 could be directly connected to one or more pool or spa devices by way of a serial connection or any other suitable direct communication protocols.

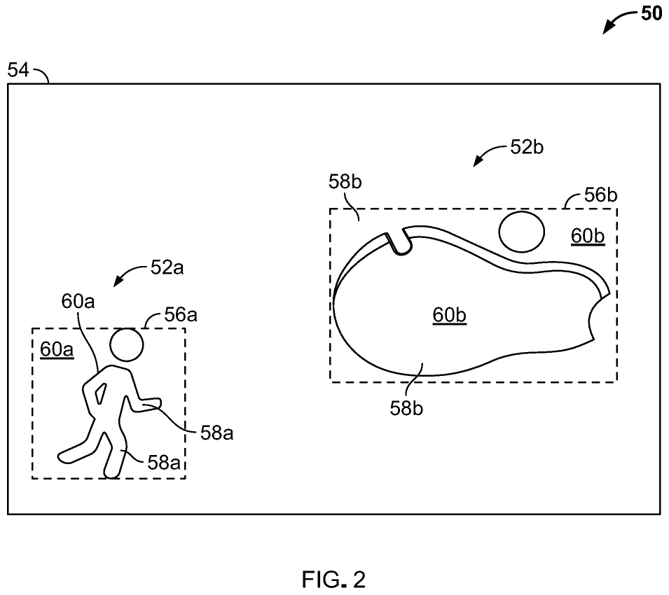

FIG. 2 is an example of an image frame, indicated generally at 50, captured by the image capture device 12 of the system 10. As shown in FIG. 2, a first object of interest 52a (e.g., a person) and a second object of interest 52b (e.g., a pool), contained within the field of view 54 of the image capture device 12, are identified within bounding boxes 56a and 56b. Within bounding boxes 56a and 56b, features of interest 58a and 58b can be identified by the system 10 and analyzed to further classify regions of the object of interest 52a and 52b. For example, as shown in FIG. 2, the first object of interest 52a includes features of interest 58a (e.g., limbs of the person) and regions 60a (the person and the area surrounding the person). Similarly, the second object of interest 52b includes feature of interest 58b (e.g., water) and regions 60b (the pool and the deck surrounding the pool). It should be understood that the image frame illustrated in FIG. 2, and discussed above, is an exemplary image frame, and in operation the image capture device 12 can capture image frames that include one of more of the pool/spa components associated with the pool, as discussed in connection with FIG. 1 (e.g., water features, pumps, lights, heaters, sanitization systems, cleaners, valves, etc.).

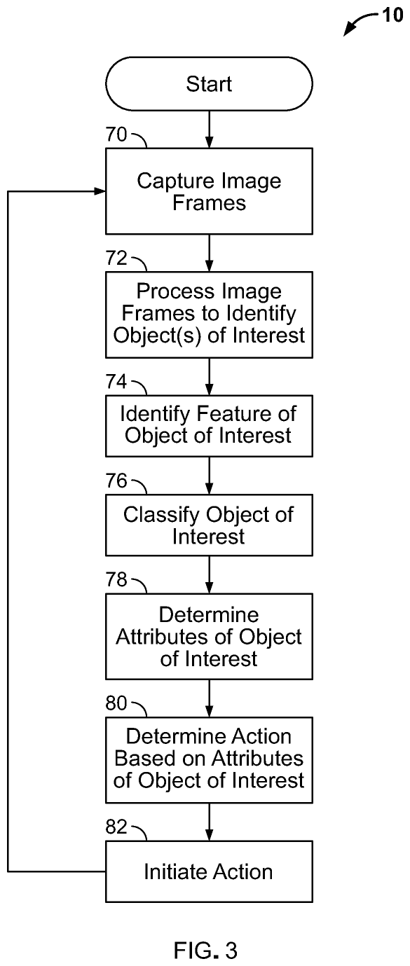

FIG. 3 is a flowchart illustrating processing steps carried out by the system 10 of the present disclosure. In step 70, the image capture device 12 captures one or more image frames of the pool/spa environment contained within the device's field of view. The process then proceeds to step 72, where the system 10 processes the one or more image frames to identify objects of interest contained therein. Specifically, the image frames are analyzed by the processor 14 using a suitable computer vision (video analysis) algorithm to detect objects of interest within the video frames. For example, such an algorithm can utilize a multi-scale strategy for refining the detection within a bounding box (see, e.g., FIG. 2) used to identify an object of interest. The process then proceeds to step 74, where the system 10 identifies features of interest of the object of interest. For example, convolutional neural networks (CNNs) can be used to identify the features of interest within the bounding box and can further classify regions of the object. Furthermore, the video analysis algorithm can include a pool of multiple convolutional neural networks that can be stacked or layered. The process then proceeds to step 76, where the system 10 classifies the object of interest. For example, the system 10 can identify a particular object of interest as a person and another object of interest as a pool or spa (see, e.g., FIG. 2). Additionally, algorithms for scene labeling can be further utilized for definition of objects or areas contained within the image/video. It is also contemplated by the present disclosure that steps 74 and 76 can be repeated one or more times in order to identify additional features of interest and further refine the object of interest classification. Steps 74 and 76 can also be repeated to identify additional features of interest if classification of the object of interest is initially unsuccessful. The process then proceeds to step 78, where the system 10 determines attributes of the objects of interest. For example, once classified, the system 10 can track and/or measure one or more objects of interest and monitor their relationship to one another (e.g., determining that an unattended toddler is approaching the pool by classifying one object of interest as a toddler, classifying another object of interest as a pool, and tracking how close the toddler is getting to the pool). The system 10 can provide advanced telemetry regarding how an object of interest interacts with the pool/spa environment and the video analysis algorithms analyze this data in order to form “learned” behaviors that enable the system to predict a required automated behavior. For example, the system 10 can retrieve pre-learned features for comparison to current object features to determine changes in appearance of the object frame by frame (e.g., determining that a person starts dancing by comparing pre-learned dancing features to current features of an object of interest classified as a person). The process then proceeds to step 80, where the system 10 determines an action to be taken based on the attributes of the objects of interest. For example, if the system 10 determines that an unattended toddler is getting too close to the pool, the system can determine that a preventative action should be taken, such as, sounding an alarm or transmitting an alert to a user's mobile device via SMS or the like. The process then proceeds to step 82, where the system initiates the action determined in step 82 and then finally returns to step 70, where the system captures additional image frames and continues to monitor the pool/spa environment.

According to the process described in connection with FIG. 3, by monitoring the pool/spa environment using the image capture device 12 and processing the information therefrom using video analytics algorithm(s) running on the processor 14, the system 10 can provide commands and feedback based on complex real-time events, thereby enabling automatic notifications and adjustment of pool/spa devices without the use of a plurality of dedicated sensors and other monitoring devices traditionally required to collect data regarding user or pool equipment behavior. For example, pool/spa water features are commonly controlled via manipulation of pump speed and a pool/spa automation system may not have the sensing devices necessary to detect if the water feature is flooding the pool/spa deck or draining the pool due to an external force (e.g., obstruction or high winds). However, according to the process described in connection with FIG. 3, the system 10 can quickly identify if a water feature 28 is no longer entering a body of water (e.g., by identifying the pool and water feature, classifying them as such, identifying their features and regions, and monitoring their relationship to one another). The system 10 can then automatically transmit an instruction to the pool/spa pump 34 or control system 24 to reduce the pump speed, thereby optimizing the operation of the water feature 28 without requiring intervention of the user. Additionally, the system 10 can provide the ability for the user to specify operation of the water feature 28 based on alternative parameters such as desired height of a water stream.

According to some aspects of the present disclosure, using the process described in connection with FIG. 3, the system 10 can also: perform object recognition of adults and/or pets to determine bather load and optimize sanitization system 30 and pump 34 operation; perform object, or facial, recognition of specific users to automatically operate specific light shows or implement other preferences; monitor usage of pool to analyze potential chemical demand and adjust the sanitization system 30; determine size or gender of user and prioritize settings; set custom safety zones for alerts based on bather detection (e.g., deep end vs. shallow end of pool) and distance from pool (e.g., 10 ft. zone around pool/spa for toddlers); monitor an individual bather, count the bather's number of laps, and adjust the lighting system colors based on number of laps or speed; identify swimmers vs. non swimmers; modify scenarios based on time of day or weather; shutoff water features based on weather (e.g., wind) or turn on pool cleaner; enable zone-based activation of pool/spa features (e.g., entering spa turns on spa or exiting shuts off spa); initiate pool/spa equipment sleep mode based on no activity being detected; detect the presence of a pool cover and use this information as a variable for alarm systems; perform water quality check (e.g., by visually monitoring water clarity, color, turbidity); perform diagnostics of pool/spa systems (e.g., identify that a light is out); recognize hand gestures and initiate commands based thereon; detect leaks on equipment pad; monitor water level; change height setting of water features remotely; recognize water feature stream (e.g., height, distance, and flow) and adjust pump or valve to optimize flow; recognize high debris in pool to activate cleaner, activate or change skimmers, or activate in-floor cleaning system; step-up chemical automation if rain is detected; monitor solar load on pool and automatically adjust pool/spa chemistry; detect unintentional fires and monitor fire safe zones (e.g., child dependent); determine whether a life guard is on duty or not and transmit an alert, alarm, or indicator; detect if a user is impaired (e.g., stumbling, swaying arms, or falling); determine that a user is dancing and automatically turn on music; notify a user if a specific person enters a designated area; communicate with lighting system or other backyard systems to perform enhanced motion and sound detection; identify specific animals entering or exiting the pool/spa environment (e.g., bear or alligator alarm); transmit an alert if pets are in proximity to designated pool/spa area; perform self-diagnostics (e.g., detect a dirty lens, connectivity issues, etc.); monitor bather load and automatically adjust filter turn-over rate; recognize when the pool is not in use and initiate an “Away Mode” to improve energy efficiency; notify a Servicer based on detected pool/spa device conditions; monitor and/or transmit an alert to a user based on time spent by particular person in a hot tub (e.g., child vs. adult); a person is detected diving into a pool/spa; transmit a notification or alert to a user when running near an activity zone (e.g., unsafe behavior) is detected; detect furniture in pool (e.g., blown in by storm) and transmit a notification or alert to a user; identify safety floatation items (e.g., swimmies or water wings); communicate with smart home devices (e.g., Alexa, google home, etc.) and home security systems; identify a pool servicer and track his/her time at the pool/spa site; determine pool/spa deck conditions (e.g., icy, slippery, etc.) and take appropriate action; determine temperature of pool/spa or deck using IR camera and provide warnings or control of pool/spa equipment; deploy awnings/shades based on determined sunshine/temperature; determine the amount of water on pool/spa cover and determine if winterization/cover mode is appropriate; recognize unsafe bathing conditions for classes of users (e.g., cleaner in pool with children, pool partially covered with children present); recognize where in the pool/spa the pool monitor resides; and determine that a bather is close to the pool/spa drain and activate an alarm.

As discussed above, the image capture device 12 of the present disclosure can include a light detection and ranging (LIDAR) system. According to some aspects of the present disclosure, the LIDAR system illuminates the pool/spa environment, or a particular object of interest, with pulsed laser light and measures the return times of reflected pulses to provide a digital three dimensional (3D) representation of the pool/spa environment or object of interest. The system 10 can then use these 3D representations of to identify objects of interest, determine attributes of the objects of interest, and take appropriate action, as discussed in connection with FIG. 3.

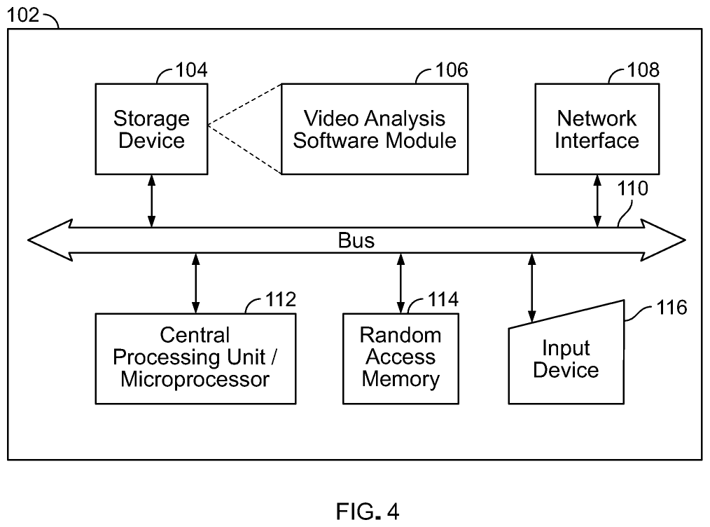

FIG. 4 is a diagram showing hardware and software components of a computer system 102 on which the system 10 of the present disclosure can be implemented. The computer system 102 can include a storage device 104, a video analysis software module 106 (computer code which carries out the processing steps described herein), a network interface 108, a communications bus 110, a central processing unit (CPU) (microprocessor) 112, a random access memory (RAM) 114, and one or more input devices 116, such as a keyboard, mouse, etc. The computer system 102 can also include a display (e.g., liquid crystal display (LCD), cathode ray tube (CRT), etc.). The storage device 104 can comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 102 can be a networked computer system, a personal computer, a server, a smart phone, tablet computer etc. It is noted that the server 102 need not be a networked server, and indeed, could be a stand-alone computer system.

The functionality provided by the present disclosure can be provided by video analysis algorithms 106, which can be embodied as computer-readable program code stored on the storage device 104 and executed by the CPU 112 using any suitable, high or low level computing language, such as Python, Java, C, C++, C#, .NET, MATLAB, etc. The network interface 108 can include an Ethernet network interface device, a wireless network interface device, or any other suitable device which permits the system 102 to communicate via a network. The CPU 112 can include any suitable single-core or multiple-core microprocessor of any suitable architecture that is capable of implementing and running the video analysis algorithms 106 (e.g., Intel processor). The random access memory 114 can include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

1. A method for monitoring a pool or spa environment and controlling operation of a pool or spa device, comprising the steps of:
receiving at least one image frame of a pool or spa environment captured using an image capture device;
processing the at least one image frame using a computer vision algorithm executed by a processor to identify at least one object of interest in the at least one image frame;
processing the at least one object of interest to classify the object of interest and to determine at least one attribute of the object of interest; and
in response to the at least one attribute of the object of interest, controlling operation of at least one pool or spa device selected from the group consisting of: a pump, a heating/cooling system, a sanitization system, a water feature, a valve actuator, a pool/spa control system, a pool cleaner, and a lighting system.

2. The method of claim 1, comprising the step of determining an action to be taken based on the at least one attribute of the object of interest.

3. The method of claim 2, comprising the step of transmitting an alert to a user based on the at least one attribute of the object of interest.

4. The method of claim 1, comprising the step of transmitting the at least one image frame to the processor via a local communication network.

5. The method of claim 1, comprising the step of transmitting the at least one image frame to a cloud-based pool or spa control system in communication with the image capture device via the Internet.

6. The method of claim 1, wherein the step of processing the at least one image frame using a computer vision algorithm to identify at least one object of interest comprises generating at least one bounding box around the at least one object of interest.

7. The method of claim 6, wherein the step of processing the at least one image frame using a computer vision algorithm to identify at least one object of interest comprises applying a multi-scale strategy for refining detection of the at least one object of interest within the bounding box.

8. The method of claim 6, comprising the step of processing the at least one image frame to identify one or more features of interest of the at least one object of interest within the bounding box.

9. The method of claim 8, comprising the step of utilizing one or more convolutional neural networks (CNNs) to identify the one or more features of interest of the at least one object of interest within the bounding box.

10. The method of claim 8, comprising the step of analyzing the one or more features of interest to classify one or more regions of the object of interest.

11. The method of claim 1, wherein the step of classifying the object of interest includes determining if the object of interest is a person.

12. The method of claim 1, wherein the step of classifying the object of interest includes using a scene labeling algorithm to define the at least one object of interest in the at least one image frame.

13. The method of claim 1, comprising the step of processing the at least one image frame to identify a second object of interest in the at least one image frame.

14. The method of claim 13, comprising the step of processing the second object of interest to classify the second object of interest and to determine at least one attribute of the second object of interest.

15. The method of claim 14, comprising the step of determining an action to be taken based on a relationship between the object of interest and the second object of interest.

16. The method of claim 15, comprising the step of automatically controlling operation of the at least one pool or spa device based on the determined action.

17. The method of claim 1, comprising the step of automatically controlling the pool or spa lighting system when the object of interest is a classified as a bather.

18. The method of claim 17, comprising the step of executing a light show of the pool or spa lighting system based on a position of the bather relative to the pool.

19. The method of claim 17, comprising the step of determining one or more attributes of the bather within the pool or spa and altering operation of the pool or spa lighting system based on one or more attributes of the bather.

20. The method of claim 19, comprising the step of adjusting the pool or spa lighting system colors based on one or more attributes of the bather.

21. The method of claim 17, comprising the step of establishing a safety zone for the pool or spa based on one or more attributes of the bather.

22. The method of claim 1, comprising the step of storing the determined attribute of the object of interest as a pre-learned attribute of the object of interest.

23. The method of claim 22, comprising the step of retrieving the pre-learned attribute of the object of interest and comparing the pre-learned attribute to a current attribute of the object of interest to determine a change in the object of interest.

24. A system for monitoring a pool or spa environment and controlling operation of a pool or spa device, comprising:
an image capture device configured to capture at least one image frame of a pool or spa environment; and
a processor in communication with the image capture device, the processor:
receiving the at least one image frame of the pool or spa environment from the image capture device;
processing the at least one image frame using a computer vision algorithm executed by the processor to identify at least one object of interest in the at least one image frame;
processing the at least one object of interest to classify the object of interest and to determine at least one attribute of the object of interest; and
determining an action to be taken based on the at least one attribute of the object of interest.

25. The system of claim 24, wherein the processor is a cloud-based pool or spa control system and the processor is in communication with the image capture device via the Internet.

26. The system of claim 24, wherein the processor controls operation of a pool or spa lighting system when the object of interest is a classified as a bather.

27. The system of claim 26, wherein the processor determines a position of the bather relative to the pool or spa and implements a specific light show of the pool or spa lighting system based on said determined positioned.

28. The system of claim 26, wherein the processor determines one or more attributes of the bather within the pool or spa and alters operation of the pool or spa lighting system based on said one or more determined attributes of the bather.

29. The system of claim 28, wherein the processor adjusts the pool or spa lighting system colors based on said one or more determined attributes of the bather.

30. The system of claim 26, wherein the processor establishes a safety zone for the pool or spa based on one or more determined attributes of the bather.
